(19) United States
(12) Patent Application Publication
(10) Pub. No.: US 2025/0362207 A1
(43) Pub. Date: Nov. 27, 2025

(54) METHOD FOR DETECTING A MALFUNCTION, TANK SYSTEM, COMPUTER PROGRAM PRODUCT, AND STORAGE MEANS

(71) Applicant: Robert Bosch GmbH, Stuttgart (DE)

(72) Inventors: Markus Strasser, Stuttgart (DE); Birgit Lenz, Korntal (DE); Christian Kuhnert, Vaihingen/Enz (DE); Christian Schugger, Stuttgart (DE); Martin Schwab, Sindelfingen (DE); Nicolas Wussler, Esslingen Am Neckar (DE); Stefan Kieferle, Stuttgart (DE)

(21) Appl. No.: 19/140,120

(22) PCT Filed: Jan. 3, 2023
(86) PCT No.: PCT/EP2023/050064

§ 371 Date: Jun. 17, 2025

(30) Foreign Application Priority Data
Sep. 15, 2022 (DE) 10 2022 209 692.4
Sep. 15, 2022 (DE) 10 2022 209 693.2
Sep. 15, 2022 (DE) 10 2022 209 697.5

(51) Int. Cl. G01M 99/00; B60K 15/03; B60K 15/063; H01M 8/0432; H01M 8/0438; H01M 8/04664

(52) U.S. Cl. CPC G01M 99/005; H01M 8/04328; H01M 8/04388; H01M 8/04664; B60K 2015/03144; B60K 2015/0319; B60K 2015/0321; B60K 2015/03315; B60K 15/063

(57) ABSTRACT

The present invention relates to a method for detecting a malfunction of a fuel outlet arrangement (16) in a tank system (11) for a fuel cell system (10), comprising the steps of: determining a transition from increased operation to reduced operation of the tank system (11) with a reduced fuel mass flow from the fuel tanks (12, 13, 14) of the tank system (11), determining a pressure build-up gradient in a fuel line arrangement (15) during the reduced operation after a defined time has elapsed after the determined transition to the reduced operation, providing a target pressure build-up gradient, performing a comparison between the determined pressure build-up gradient during reduced operation and the provided target pressure build-up gradient, and detecting a malfunction of the fuel outlet arrangement (16) based on the comparison. The invention also relates to a tank system (11) and a computer program product (23) for carrying out the method, as well as a computer-readable storage medium (24) on which such a computer program product (23) is stored.

### BACKGROUND

The present invention relates to a method for detecting a malfunction, in particular in a fuel cell system, in particular in a tank system of a fuel cell system. The invention also relates to a tank system in which or with which such a method can be carried out, a corresponding computer program product, and a computer-readable storage medium on which such a computer program product is stored.

Fuel cell systems usually have complex tank systems. DE 10 2017 212 485 A1, for example, describes a system for storing fuel in a tank system for a vehicle, wherein the tank system comprises tubular tank containers and a high-pressure fuel distributor with integrated control and safety technology. The tank containers are made of metal and are connected to the high-pressure fuel distributor with integrated control and safety technology in a modular fashion to form a module with a flexible geometry.

### SUMMARY

During operation, the tank containers should be protected as well as possible against mechanical and/or thermal stresses such as vibrations, braking, or acceleration. This also applies to the protection of the tank containers in the event of an accident. Furthermore, it is desirable to monitor the tank system at all times in order to detect any malfunctions in the tank system as early as possible. This always poses a challenge when using multiple tank containers.

The present invention proposes solutions for improving known methods and systems for detecting a malfunction in a tank system, in particular in a fuel cell system. In particular, a method according to the disclosure, a tank system according to the disclosure, a computer program product according to the disclosure and a computer-readable storage medium according to the disclosure are proposed. Further embodiments of the invention arise from the dependent claims, the description, and the figures. Features that are described in connection with the method also apply in connection with the tank system according to the invention, the computer program product according to the invention, the storage medium according to the invention and vice versa, so that reference is and/or can always be made reciprocally to the individual aspects of the invention with regard to the disclosure.

According to a first aspect of the present invention, a method for detecting a malfunction of a fuel outlet arrangement in a tank system, in particular for a fuel cell system, is proposed, wherein the tank system comprises a plurality of fuel tanks, a fuel line arrangement for conducting fuel from the fuel tanks, and a fuel outlet arrangement each with an outlet means for each fuel tank for the controlled conducting of fuel from the fuel tanks into the fuel line arrangement. The method has the following steps:
determining a transition from an increased operation to a reduced operation of the tank system with a reduced fuel mass flow from the fuel tanks,
determining a pressure build-up gradient in the fuel line arrangement during the reduced operation after a defined time has elapsed since the determined transition to reduced operation,
providing a target pressure build-up gradient,
performing a comparison between the determined pressure build-up gradient during the reduced operation and the provided target pressure build-up gradient, and
detecting a malfunction of the fuel outlet arrangement based on the comparison.

Within the scope of the present invention, it has been discovered that meaningful conclusions regarding a possible malfunction of the fuel outlet arrangement can be drawn relatively easily on the basis of a determinable pressure build-up gradient during reduced operation of the tank system. If all outlet valves of the outlet means on the fuel tanks comply with the permissible pressure drop, a brief pressure increase will occur when switching to a reduced fuel mass flow or consumer mass flow. This means that an increased valve throttle effect on an individual fuel tank leads to a higher tank pressure in this fuel tank compared to the other fuel tanks during a tank empty run with a high fuel mass flow or during increased operation with an increased or higher fuel mass flow. The one faulty fuel tank is running behind, so to speak. If the tank system is subsequently operated with a sufficiently small or with the predefined and/or predefinable reduced fuel mass flow, this can lead to refilling from one fuel tank to the other tanks. Thus, due to the refilling, after a conventionally short pressure increase to the tank pressure level of the lowest tank pressure, a long and/or longer and overall still higher pressure increase in the fuel line arrangement can be seen. By detecting this pressure increase, the refilling and thus a corresponding malfunction in the form of asymmetric tank emptying can now be inferred. In particular, to detect the malfunction, a second pressure increase that is greater than and/or longer than a first pressure increase is detected during reduced operation in the determined pressure build-up gradient and used for the comparison.

Thus, determining the pressure build-up gradient in the fuel line arrangement during reduced operation after a defined time, for example after electrically actuating the outlet means, can be understood to mean that the pressure build-up gradient is determined during reduced operation in a predefined time, in a pre-definable time, and/or simply in a time that is after the first small pressure increase. The reduced operation can be understood as an operation of the tank system in which the fuel mass flow is small enough to allow for the refilling described above. As already mentioned above, the reduced operation is to be understood in particular as an operation in which a lower fuel mass flow is present than during the increased operation, in particular less by a predefined or pre-definable value.

Based on the comparison according to the invention or by means of the comparison according to the invention, a malfunction can be detected in particular in that a clogged extraction filter of an outlet means is detected. Accordingly, the malfunction can be understood as a degree of clogging of an extraction filter of at least one outlet means which is above a reference degree of clogging or a predefined and/or predefinable maximum permissible degree of clogging. If an excessive degree of fouling is detected, appropriate countermeasures can be initiated to address any problems that can arise. In particular, operation of the fuel cell system or the tank system can be prevented if a fuel tank cannot or would not be emptied as desired or would not be available as desired for supplying fuel. Furthermore, the comparison and/or malfunction can be used in order to infer refilling of a tank of the tank system and/or refilling of a plurality of tanks of the tank system.

As part of the method, predefined measures can also be initiated based on the detected and/or displayed malfunction and/or knowledge of the refilling. This means that if the malfunction or at least one malfunction is detected, at least one predefined measure can be initiated. The measure can be understood to mean the output of a visual and/or acoustic warning signal. The warning signal can be audibly and/or visually perceptible to a user of the tank system and/or the fuel cell system, for example in the form of a driver of a vehicle with the fuel cell system.

The malfunction can be detected and then displayed. The display of the malfunction can be understood to mean the output of a warning signal as described above. Furthermore, displaying the malfunction can be understood to mean generating a warning signal that is stored in a memory from which it can be read out by a specialist, for example during an inspection of the tank system. The read-out warning signal can be used in order to draw conclusions about a malfunction, for example the refilling, that can have occurred or is still present. Measures can then be taken to prevent the malfunction, at least in the future.

The outlet means can have outlet valves which, in a method according to the invention, can all be electrically actuated simultaneously or essentially simultaneously. In particular, the outlet valves can be controlled in parallel during startup of the fuel cell system or during operation of the fuel cell system.

The pressure buildup gradient is preferably determined in a high-pressure line section of the fuel line arrangement. The pressure buildup gradient is preferably determined by pressure measurements and a pressure evaluation of a line pressure in the fuel line arrangement over time. The pressure buildup gradient can therefore be determined using suitable measurement sensors and a computing unit that is connected to the measurement sensors. The measuring sensor system can have at least one pressure sensor for determining the pressure buildup gradient.

The comparison according to the invention between the determined pressure buildup gradient and the provided target pressure buildup gradient is carried out in particular when no pressure buildup is measured in a medium-pressure line section of the fuel line arrangement in which the gas pressure is at least on average lower than in the high-pressure line section, or no pressure build-up can be detected by measurement. In this way, the tightness of a pressure controller in the fuel line arrangement can be checked to ensure that the mass flow through the respective outlet valve was only effective for the pressure build-up in the high-pressure line section.

The provision of the target pressure buildup gradient can be understood to mean that the target pressure buildup gradient is read from a memory and thereby made available for comparison, or is first calculated and only then made available for comparison. This means that the provision can also include determining and/or calculating the target pressure buildup gradient and then providing it.

The outlet valves can be understood as tank valves that are installed directly or essentially directly on the fuel tanks. A suitable extraction filter can be positioned at each outlet valve. The outlet valve and extraction filter preferably form the essential and/or sole component of the respective outlet means. The fuel tanks are preferably hydrogen tanks. Detecting and possibly displaying a malfunction of the fuel outlet arrangement based on the comparison can be understood to mean that the at least one malfunction can be detected and displayed using the comparison or a comparison result. This means that the comparison result can be evaluated accordingly to detect and display the malfunction and/or taken into account in a suitable calculation. The method can be carried out in particular to detect a malfunction of a fuel outlet arrangement in a fuel cell system of a vehicle, in particular during operation of the fuel cell system in the vehicle. However, the method is not limited to being configured as a fuel cell system. For example, the malfunction can also be detected in a fuel outlet arrangement or gas outlet arrangement in a tank system for another gas system. In the present case, fuel can generally be understood as any combustible gas.

The method steps according to the invention do not have to be carried out in the specified order. Individual method steps can also be carried out in a different sequence and/or simultaneously. For example, it is possible that the target pressure build-up gradient is first provided and/or calculated and only then is the actual refilling value determined.

If, for example, the comparison reveals that the determined pressure build-up gradient is less than the target pressure build-up gradient by a predefined value, this can indicate a malfunction, in particular a clogged extraction filter. For example, a difference between the target pressure build-up gradient and the determined pressure build-up gradient, or between the individual values of the gradient or the value curve, can be calculated as part of the comparison. This difference can be compared to a predefined threshold value and/or a reference difference. If the difference is greater than the predefined threshold value or the reference difference, a malfunction as described above can be concluded.

According to one embodiment, it is possible that the following steps are carried out in a method:
determining a tank pressure in the respective fuel tank during reduced operation,
determining a line pressure in the fuel line arrangement,
performing comparisons between the tank pressure in the respective fuel tank and the line pressure, and
detecting a malfunction of at least one specific fuel tank and/or at least one specific outlet means based on the comparisons between the tank pressure in the particular fuel tank and the line pressure.

In this way, the malfunction can be determined particularly reliably and/or the actual presence of a malfunction can be checked easily. If a second or longer pressure increase in the fuel line arrangement described above is used in order to indicate a malfunction, for example the added extraction filter, this can now be checked and specified. In particular, it is possible to determine which tank contains the potentially clogged extraction filter. However, such a determination and/or associated calculations only need to be carried out if there is reason to do so based on the detection of a possible malfunction as described above. In other words, if no indication of a malfunction is found based on the initial comparison, subsequent calculations to determine a more accurate cause of the error can be omitted. This allows the process to be carried out with low computing capacity and thus in an energy-efficient manner.

The following additional or alternative steps are possible for a further check:
determining a tank pressure in the respective fuel tank during reduced operation,
performing comparisons between the respective determined tank pressures in the fuel tanks, and
detecting a malfunction of at least one specific fuel tank and/or at least one specific outlet means based on the comparisons between the respectively determined tank pressures in the fuel tanks.

The following additional or alternative steps are also possible:
determining a fuel level in the respective fuel tank during reduced operation,
performing comparisons between the respective determined fuel level in the fuel tanks, and
detecting a malfunction of at least one specific fuel tank and/or at least one specific outlet means based on the comparisons between the respectively determined fuel levels in the fuel tanks.

This is another particularly reliable way of determining or checking and specifying the malfunction. Furthermore, it is possible that the defined time is determined in a method according to the invention as a function of a line pressure in the fuel line arrangement and/or a change value of a mass reduction in the transition to the reduced operation. In this way, a point in time that is as suitable as possible or a corresponding time for determining the pressure build-up gradient can be defined and consequently used for carrying out a correspondingly meaningful comparison.

In addition, it is possible that, in a method according to the invention, the method steps are performed only after a defined or definable transition time after opening the outlet means. That is to say, the method can be carried out in such a way that an opening of the outlet means is detected, the transition time is subsequently waited, and the further method steps are only carried out subsequently or at a defined or definable start time. In this way, in particular, it can be prevented that a malfunction is detected, which is not actually a malfunction. For example, if a vehicle with a tank system stands in the sun on one side for an extended period of time, the tanks exposed to direct sunlight can heat up more strongly than the tanks in the shade. If the outlet means for opening the same is now actuated, different gas pressures are initially applied to the tanks, which, however, stabilize over time. If the method according to the invention would now be carried out right at the beginning, i.e. directly after actuation of the outlet means, an undesirable pressure build-up gradient due to a malfunction and a pressure build-up gradient due to the solar irradiation described above could not possibly be differentiated. The transition time can be defined or preset with some certainty based on empirical values, or can be defined as a function of current operating and/or environmental parameters.

Furthermore, in a method according to the present invention, it is possible that a temperature in and/or at the respective fuel tank is determined and the transition time is defined or set, as a function of the determined temperature in and/or at the respective fuel tank. The at least one temperature is determined in particular in the respective fuel tank. Based on the temperature in and/or on the fuel tank, the transition time can be reliably inferred, which is to be waited until the target pressure compensation is present or until a compensation between the different tank pressures has stabilized. Nevertheless, in addition to the temperature in and/or at the particular fuel tank, there can be still further information considered in order to define the transition time.

In a method according to the invention, it is also possible for the target pressure build-up gradient to be calculated as a function of a current line pressure in the fuel line arrangement and provided for comparison. In this way, the target pressure build-up gradient can be calculated correspondingly as a function of the operating state and/or functional state of the tank system. Consequently, the target pressure build-up gradient can always be provided relatively accurately in various operating and/or functional states of the fuel cell system. The target pressure build-up gradient being calculated as a function of the current line pressure can be understood to mean that the current line pressure is determined with suitable sensors and the target pressure build-up gradient is then calculated using the determined line pressure. The current line pressure is determined in particular after electrically actuating the outlet means.

The target pressure build-up gradient can additionally or alternatively be calculated and provided for comparison as a function of a current temperature in the fuel line arrangement. Again, the target pressure build-up gradient can always be provided relatively accurately in various operating and/or functional conditions of the fuel cell system.

Moreover, it is possible that the target pressure build-up gradient, additionally or alternatively, can be calculated as a function of a current tank pressure prior to electrically actuating the outlet means, in particular the outlet valves. That is to say, first the current tank pressure, in particular with suitable sensor technology, can be determined, and then the electrical outlet valves can be controlled. The target pressure build-up gradient can now be calculated using the current tank pressure and provided or used for comparison. The calculations described in the present case are preferably carried out with a computing unit, which can be part of, for example, a control unit, in particular a vehicle control unit. Nevertheless, the computing unit or a part of the computing unit can also be provided remotely, for example in a cloud, and used for calculating the target pressure build-up gradient. The current tank pressure can be understood to mean a tank pressure determined as soon as possible before electrically actuating the outlet valves and/or as soon as possible after a start of operation of the fuel cell system. The current tank pressure can be calculated from a line pressure determined during a previous operation of the fuel cell system, i.e. prior to electrically actuating the outlet valves in a subsequent operation of the fuel cell system. A previous tank pressure can be determined based on the line pressure from the previous operation, which, in order to calculate the current tank pressure, can be corrected or changed based on determined temperature differences between the two operations in the fuel tanks. In this way, the current tank pressure can be determined without a pressure sensor in the fuel tanks. The respective tank pressure can further be determined by a pressure sensor in the particular fuel tank. Furthermore, in a method according to the present invention, the target pressure build-up gradient can be calculated and provided for comparison as a function of a volumetric value of a volume in the fuel line arrangement. This procedure helps in calculating a target pressure build-up gradient that is as accurate as possible or in calculating a target pressure build-up gradient that is as close as possible to a desired ideal pressure build-up gradient. The volumetric value can correspond to a volume defined by the fuel line arrangement. The volumetric value preferably corresponds to a high-pressure line section of the fuel line arrangement. In experiments in the context of the present invention, it has further proven advantageous for a method to calculate and provide the target pressure build-up gradient for comparison as a function of a number of the outlet valves. Based on this system-specific parameter, the target pressure build-up gradient can also be calculated relatively precisely or as desired in a simple manner. Alternatively or additionally, a throttle response of the outlet valves can further be determined and used in order to calculate the target pressure build-up gradient.

Another aspect of the present invention relates to a tank system for a fuel cell system, comprising a plurality of fuel tanks, a fuel line arrangement for conducting fuel from the fuel tanks, and a fuel outlet arrangement each with an outlet means for each fuel tank for controlled conducting of fuel from the fuel tanks through the fuel line arrangement. The tank system further includes a determination unit for determining a transition from increased operation to reduced operation of the tank system with a reduced fuel mass flow from the fuel tanks and for determining a pressure build-up gradient in the fuel line arrangement during the reduced operation after a defined time has elapsed after the determined transition to the reduced operation, and a computing unit for performing a comparison between the determined pressure build-up gradient during reduced operation and the provided target pressure build-up gradient, as well as for detecting a malfunction of the fuel outlet arrangement based on the comparison. The tank system according to the invention thus has the same advantages as those described in detail with reference to the method according to the invention. The tank system can further comprise a control unit for electrically actuating the outlet means and thus correspondingly opening and closing the outlet means. The target pressure buildup gradient can be calculated by means of a computing unit and/or read out from a memory in order to perform the comparison. The computing unit can be configured and designed to calculate the target pressure buildup gradient in the manner described in detail above. The tank system can be configured and designed as part of a fuel cell system. The fuel cell system can be configured and designed as part of a vehicle.

The invention also proposes a tank system that is configured and designed to carry out the method described above. This means that the tank system can have suitable sensors, a suitable computing unit, and/or suitable actuators for carrying out the method.

A further aspect of the invention relates to a computer program product comprising commands which cause the method steps according to the invention to be carried out in a tank system as described above. The invention also relates to a computer-readable, in particular non-volatile, storage medium on which such a computer program product is stored. The computer program product according to the invention and the storage medium thus also have the advantages described above.

The computer program product can be implemented as computer-readable instruction code in any suitable programming language and/or machine language such as JAVA, C++, C#and/or Python. The computer program product can be stored on a computer-readable storage medium such as a data disc, removable drive, volatile or non-volatile memory, or a built-in memory/processor. The instruction code can program a computer or other programmable device, such as a control device of the fuel cell system and/or a vehicle with the fuel cell system, to perform the desired functions. Furthermore, the computer program product can be and/or can be provided on a network, such as the Internet, from which it can be downloaded by a user on demand. The computer program product can be realized by means of software as well as by means of one or more special electronic circuits, i.e. in hardware or in any hybrid form, i.e. by means of software components and hardware components.

### BRIEF DESCRIPTION OF THE DRAWINGS

Further measures that improve the invention are shown in the following description of various exemplary embodiments of the invention, which are shown schematically in the figures. All features and/or advantages resulting from the claims, the description, or the figures, including design details and spatial arrangements, can be essential to the invention both individually and in the various combinations.

It shows schematically in each case:

FIG. 1 a fuel cell system with a tank system according to one embodiment of the present invention,

FIG. 2 a tank system according to one embodiment of the present invention,

FIG. 3 storage means with a computer program product stored thereon according to an embodiment of the present invention, and

FIG. 4 a flowchart explaining a method according to one embodiment of the present invention.

### DETAILED DESCRIPTION

Elements having the same function and mode of action are in each case provided with the same reference signs in the figures.

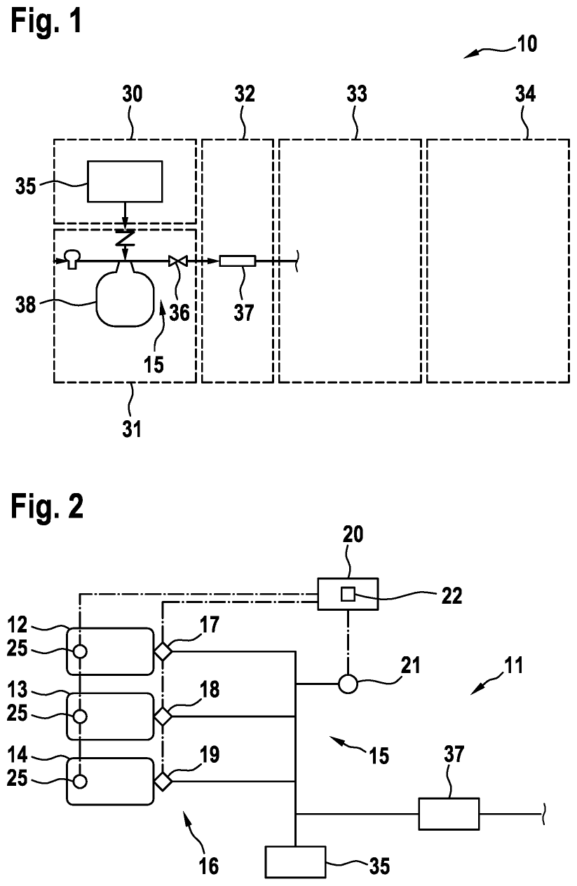

FIG. 1 shows a fuel cell system 10 that is configured and designed for mobile use in a vehicle. The fuel cell system 10 has a filling section 30 with a tank connection 35 in the form of a connection nozzle. The fuel cell system 10 further comprises a storage section 31 with a fuel line arrangement 15, a fuel tank arrangement 38 and a valve 36 in the form of a shut-off or shut-off valve. In addition, the fuel cell system 10 has a supply section 32 with a pressure controller 37, through which the fuel can be fed in a controlled manner from the storage section 31 into a fuel cell section 33 of the fuel cell system 10. In addition, the fuel cell system 10 has a power section 34 in which the current or voltage generated in the fuel cell section 10 can be converted into drive power for the vehicle.

FIG. 2 shows a tank system 11 for a fuel cell system 10 as shown in FIG. 1. The tank system 11 shown in FIG. 2 has three fuel tanks 12, 13, 14, a fuel line arrangement 15 for conducting fuel from the fuel tanks 12, 13, 14 and a fuel outlet arrangement 16 for controlled conducting of fuel from the fuel tanks 12, 13, 14 through the or into the fuel line arrangement 15. The fuel tanks 12, 13, 14 are connected to the fuel line arrangement 15 in parallel. The fuel outlet arrangement 16 has three outlet means 17, 18, 19, wherein one outlet means 17, 18, 19 is installed on each fuel tank 12, 13, 14. Each outlet means 17, 18, 19 has an outlet valve and an extraction filter (not shown in detail). Furthermore, a pressure sensor 25 is provided in each tank for determining a gas pressure in the respective fuel tank 12, 13, 14. The tank system 11 further comprises a control unit 20 for actuating the outlet means 17, 18, 19. The control unit 20 is shown schematically and can have several components mutually spaced. The control unit 20 can have a control device, in particular in the form of a central vehicle control device.

In addition, the tank system 11 comprises a determination unit 21 having a further pressure sensor for determining a transition from an increased operation to a reduced operation of the tank system 11 with a reduced fuel mass flow from the fuel tanks 12, 13, 14, and for determining a line pressure, and in particular for determining a pressure build-up gradient in the fuel line arrangement 15, during the reduced operation after a predefined time has elapsed after a determined transition to the reduced operation. According to the embodiment shown in FIG. 2, a component of the control unit 20 is a computing unit 22 for carrying out a comparison between the determined pressure build-up gradient during reduced operation and a provided target pressure build-up gradient and for detecting a malfunction of the fuel outlet arrangement 16, in particular in the form of an added extraction filter, based on the comparison.

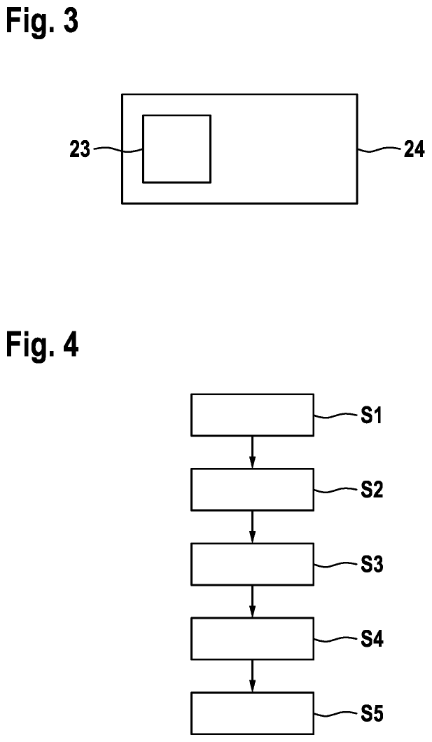

FIG. 3 shows a computer-readable, non-volatile storage medium 24 in the form of a memory stick. A computer program product 23 is stored on the storage medium 24. The computer program product 23 comprises commands that cause the tank system 11 shown in FIG. 1 and FIG. 2 to execute a method, which is subsequently explained with reference to FIG. 4.

With reference to the flowchart shown in FIG. 4, a method for detecting a malfunction of the fuel outlet arrangement 16 described above is explained. More precisely, the method can be used in order to find out whether or not the fuel outlet arrangement 16 has a malfunction, in particular in the form of at least one clogged extraction filter, in which a tank refilling occurs. For this purpose, the outlet means 17, 18, 19 for simultaneously opening the outlet valves in a first step S1 are initially electrically actuated or powered in parallel. In a second step S2, a reduced operation of the tank system 11 is determined in the fuel line arrangement 15 by means of the determination device 21, and in particular a transition from an increased operation to reduced operation in which the fuel mass flow from the fuel tanks 12, 13, 14 is so small that a refill of fuel tanks 12, 13, 14 to be detected is possible. In a defined time after or since the determined transition, a pressure build-up gradient is determined in the fuel line arrangement. In a third step S3, which does not necessarily have to be carried out after the second step S2, a target pressure build-up gradient is provided. According to the described embodiment, the target pressure build-up gradient is determined taking into account or using a determined current line pressure in the fuel line arrangement 15, which is calculated and subsequently provided accordingly. In a subsequent step S4, a comparison between the determined pressure build-up gradient and the calculated and provided target pressure build-up gradient is carried out using the computing unit 22. In a fifth step S5, a malfunction of the fuel outlet arrangement 16 is detected based on the comparison and concretized or represented as a corresponding error signal using the detected malfunction. In other words, the comparison is used in order to determine whether or not there is a malfunction in the fuel outlet arrangement 16, in particular in the form of at least one clogged extraction filter.

The invention allows for further design principles in addition to the illustrated embodiments. That is to say, the invention is not intended to be limited to the exemplary embodiments explained with reference to the figures. In particular, the pressure sensors 25 in the respective fuel tanks 12, 13, 14 could be dispensed with. If the pressure sensors 25 are present, the following steps can be carried out to detect the malfunction: determining a tank pressure in the particular fuel tank 12, 13, 14 during reduced operation, determining a line pressure in the fuel line arrangement 15, performing comparisons between the tank pressure in the respective fuel tank 12, 13, 14 and the line pressure, and detecting a malfunction of at least one specific fuel tank 12, 13, 14 and/or at least one specific outlet means 17, 18, 19 based on the comparisons between the tank pressure in the respective fuel tank 12, 13, 14 and the line pressure.

Alternatively or additionally, it is possible to carry out the following steps: determining a tank pressure in the respective fuel tank 12, 13, 14 during reduced operation, performing comparisons between the determined tank pressures in the fuel tanks 12, 13, 14, and detecting a malfunction of at least one specific fuel tank 12, 13, 14 and/or at least one specific outlet means 17, 18, 19 based on the comparisons between the respectively determined tank pressures in the fuel tanks 12, 13, 14. Furthermore, it is possible to carry out the following steps, additionally or alternatively: determining a fuel level in the particular fuel tank 12, 13, 14 during reduced operation, performing comparisons between the determined fuel levels in fuel tanks 12, 13, 14, and detecting a malfunction of at least one specific fuel tank 12, 13, 14 and/or at least one specific outlet means 17, 18, 19 based on the comparisons between the respectively determined fuel levels in the fuel tanks 12, 13, 14.

1. A method for detecting a malfunction of a fuel outlet arrangement (16) in a tank system (11), wherein the tank system (11) has several fuel tanks (12, 13, 14), a fuel line arrangement (15) for conducting fuel from the fuel tanks (12, 13, 14), and a fuel outlet arrangement (16) each with an outlet means (17, 18, 19) for each fuel tank (12, 13, 14) for the controlled conducting of fuel from the fuel tanks (12, 13, 14) through the fuel line arrangement (15),
the method comprising:
determining a transition from an increased operation to a reduced operation of the tank system (11) with a reduced fuel mass flow from the fuel tanks (12, 13, 14),
determining a pressure build-up gradient in the fuel line arrangement (15) during the reduced operation after a defined time has elapsed since the determined transition to reduced operation,
providing a target pressure build-up gradient,
performing a comparison between the determined pressure build-up gradient during the reduced operation and the provided target pressure build-up gradient, and
detecting a malfunction of the fuel outlet arrangement (16) based on the comparison.

2. The method according to claim 1,
wherein
the defined time is determined as a function of a line pressure in the fuel line arrangement (15) and/or a change value of a mass reduction in the transition to the reduced operation.

3. The method according to claim 1,
wherein
the method steps are performed only after a defined or definable transition time after opening the outlet means (17, 18, 19).

4. The method according to claim 3,
wherein
determining a temperature in and/or on the particular fuel tank (12, 13, 14) and defining the transition time as a function of the determined temperature in and/or on the particular fuel tank (12, 13, 14).

5. The method according to claim 1,
wherein
the target pressure build-up gradient is calculated and provided for comparison as a function of a current line pressure in the fuel line arrangement (15).

6. The method according to claim 1,
wherein
the target pressure build-up gradient is calculated and provided for comparison as a function of a current temperature in the fuel line arrangement (15).

7. A tank system (11) for a fuel cell system (10), comprising:
a plurality of fuel tanks (12, 13, 14),
a fuel line arrangement (15) for conducting fuel from the fuel tanks (12, 13, 14), and a fuel outlet arrangement (16) each with an outlet means (17, 18, 19) for each fuel tank (12, 13, 14) for the controlled conducting of fuel from the fuel tanks (12, 13, 14) through the fuel line arrangement (15),
a determination unit (21) having a further pressure sensor for determining a transition from an increased operation to a reduced operation of the tank system (11) with a reduced fuel mass flow from the fuel tanks (12, 13, 14), and for determining a pressure build-up gradient in the fuel line arrangement (15), during the reduced operation after a defined time has elapsed after the determined transition to the reduced operation, and
a computing unit (22) for carrying out a comparison between the determined pressure build-up gradient during reduced operation and a provided target pressure build-up gradient and for detecting a malfunction of the fuel outlet arrangement (16) based on the comparison.

8. The tank system (11) according to claim 7, which is configured and designed to perform a method claim 1.

9. (canceled)

10. A non-transitory, computer-readable storage medium (24) comprising instructions that when executed by a computer cause the computer to detect a malfunction of a fuel outlet arrangement (16) in a tank system (11), wherein the tank system (11) has several fuel tanks (12, 13, 14), a fuel line arrangement (15) for conducting fuel from the fuel tanks (12, 13, 14), and a fuel outlet arrangement (16) each with an outlet means (17, 18, 19) for each fuel tank (12, 13, 14) for the controlled conducting of fuel from the fuel tanks (12, 13, 14) through the fuel line arrangement (15), by:
determining a transition from an increased operation to a reduced operation of the tank system (11) with a reduced fuel mass flow from the fuel tanks (12, 13, 14),
determining a pressure build-up gradient in the fuel line arrangement (15) during the reduced operation after a defined time has elapsed since the determined transition to reduced operation,
providing a target pressure build-up gradient,
performing a comparison between the determined pressure build-up gradient during the reduced operation and the provided target pressure build-up gradient, and
detecting a malfunction of the fuel outlet arrangement (16) based on the comparison.
